(19) United States
(12) Patent Application Publication
(10) Pub. No.: US 2016/0340014 A1
(43) Pub. Date: Nov. 24, 2016

(54) BALLAST WATER TREATMENT DEVICE

(71) Applicant: MIURA CO., LTD., Matsuyama-shi, Ehime-ken (JP)

(72) Inventors: Tomoaki TANGE, Matsuyama-shi, Ehime-ken (JP); Akinori KAWAKAMI, Matsuyama-shi, Ehime-ken (JP); Yasuhiko SAITO, Matsuyama-shi, Ehime-ken (JP)

(73) Assignee: MIURA CO., LTD., Matsuyama-shi, Ehime-ken (JP)

(21) Appl. No.: 15/032,237

(22) PCT Filed: Dec. 5, 2014
(86) PCT No.: PCT/JP2014/082237

§ 371 Date: Apr. 26, 2016

(30) Foreign Application Priority Data
Jan. 31, 2014 (JP) 2014-016913

(51) Int. Cl. B63J 4/00; C02F 1/00; C02F 1/32; B63B 13/00

(52) U.S. Cl. CPC B63J 4/002; B63B 13/00; C02F 1/008; C02F 1/32; C02F 1/001; C02F 2103/008

(57) ABSTRACT

The present invention includes: a ballast water treatment line (4) having a treatment target water suction pump (1), a filter (2) that filters treatment target water, and a ballast tank (3) that stores filtered treatment water; a treatment target water overboard discharge line (6) having a treatment target water overboard discharge unit (5) that discharges treatment target water overboard; and a treatment water overboard discharge line (10) having a treatment water suction pump (7) that sucks treatment water in the ballast tank (3), an ultraviolet reactor (8) that treats treatment water with ultraviolet radiation, and a treatment water overboard discharge unit (9) that discharges treatment water treated with ultraviolet radiation overboard. When treatment water is sucked, treatment water in the ballast tank (3) is sucked, passes through the ultraviolet reactor (8) to be treated with ultraviolet radiation, and is discharged overboard from the treatment water overboard discharge line (10).

### TECHNICAL FIELD

The present invention relates to a ballast water treatment device that treats ballast water stored in a vessel.

### BACKGROUND ART

A vessel such as a tanker usually stores water called ballast water in a ballast tank disposed on the vessel in order to balance the vessel under way while traveling toward another destination after unloading freight such as crude petroleum. Ballast water is normally charged at an unloading port and discharged at a loading port. Therefore, if these ports are located at different places, microorganisms such as plankton and bacteria in the ballast water comes to travel all over the world. Thus, ballast water is discharged at a loading port in a sea area different from that of an unloading port, and microorganisms in another sea area are released at the loading port and may destroy the ecosystem in the sea area. In order to prevent the marine environment from being destroyed by such ballast water, the International Maritime Organization (IMO) has entered into the International Convention for the Control and Management of Ships' Ballast Water and Sediments, and has set a ballast water discharge standard to restrict the microorganism content in ballast water discharged from ships.

This ballast water discharge standard sets the discharge limits for plankton according to sizes, specifically, not more than 10 individuals/m³ for plankton of 50 μm or more and not more than 10 individuals/ml for plankton of 10 to 50 μm. The ballast water discharge standard also sets the discharge limits for bacteria, such as less than 250 cfu/100 ml for coliform bacteria.

Ballast water to be stored in a ballast tank is thus required to be treated by killing microorganisms or the like in the ballast water.

A known method for killing microorganisms or the like in ballast water includes an ultraviolet treatment process of irradiating treatment target water sucked as ballast water with ultraviolet rays (for example, see Patent Literature 1). The ultraviolet treatment of treatment target water sucked as ballast water in such a ballast water treatment device has effects only when treatment target water passes through an ultraviolet reactor, and hardly has continuous effects on treatment water having been subjected to the ultraviolet treatment. When treatment water stored in the ballast tank is discharged from a vessel, the treatment water is discharged without a particular treatment.

However, since there is concern that microorganisms or the like survive in the treatment water having been subjected to the ultraviolet treatment and can increase on a voyage, there has been disclosed a ballast water treatment device that performs an ultraviolet treatment again to the treatment water when the treatment water is discharged (for example, see Patent Literature 2).

### PRIOR ART LITERATURE

### Patent Literature

Patent Literature 1: JP-A-2011-255365
Patent Literature 2: JP-A-2012-217966

### DISCLOSURE OF THE INVENTION

### Problems to be Solved by the Invention

However, since the ballast water treatment device disclosed in Patent Literature 2 performs an ultraviolet treatment to each of the treatment target water during suction of ballast water and the treatment water during discharge, there is a problem that electric power is consumed twice more than that for the ultraviolet treatment to treatment target water during suction of ballast water, leading to reduction by half of the life of an ultraviolet lamp and increase of a running cost.

The present inventors intensively conducted tests and researches in order to solve the above-described problem. As a result, the present inventors paid attention on the fact that the problem with ballast water is microorganisms existing in ballast water when the ballast water is discharged from a vessel. Thus, the present invention has been achieved.

An objective of the present invention is to provide a ballast water treatment device that performs an ultraviolet treatment to microorganisms existing in ballast water stored in a vessel when discharging the ballast water, in order to reliably and efficiently perform a sterilization treatment to the ballast water as well as reduce a running cost.

### Solutions to the Problems

In order to achieve the above-described objective, the invention according to claim 1 is a ballast water treatment device including: a ballast water treatment line having a treatment target water suction pump that sucks treatment target water, a filter that filters sucked treatment target water, and a ballast tank that stores filtered treatment water, in this order; a treatment target water overboard discharge line having a treatment target water overboard discharge unit that discharges sucked treatment target water overboard; and a treatment water overboard discharge line having a treatment water suction pump that sucks treatment water in the ballast tank, an ultraviolet reactor that treats sucked treatment water with ultraviolet radiation, and a treatment water overboard discharge unit that discharges treatment water treated with ultraviolet radiation overboard, in which when treatment target water is sucked, sucked treatment target water is discharged overboard from the treatment target water overboard discharge line by the treatment target water overboard discharge unit without passing through the filter for a prescribed time from the start of suction of treatment target water by the treatment target water suction pump, and when the prescribed time elapsed, the overboard discharge from the treatment target water overboard discharge line by the treatment target water overboard discharge unit is terminated, treatment target water passes through the filter to be filtered, and filtered treatment water is poured into the ballast tank, and when treatment water is sucked, treatment water in the ballast tank is sucked by the treatment water suction pump, sucked treatment water passes through the ultraviolet reactor to be treated with ultraviolet radiation, and treated treatment water is discharged overboard from the treatment water overboard discharge line by the treatment water overboard discharge unit.

According to the invention of claim 1, when treatment target water is sucked, sucked treatment target water is discharged overboard from the treatment target water overboard discharge line by the treatment target water overboard discharge unit without passing through the filter for a prescribed time from the start of suction of treatment target water, and when the prescribed time elapsed, the overboard discharge from the treatment target water overboard discharge line by the treatment target water overboard discharge unit is terminated, and treatment target water passes through the filter to be filtered. Therefore, clogging of the filter due to the turbidity during suction is mitigated, and treatment water in which large-sized microorganisms or the like present in treatment target water have been trapped by a filtration treatment with the filter can be poured into the ballast tank. When treatment water is sucked, sucked treatment water passes through the ultraviolet reactor to be treated with ultraviolet radiation, and treated treatment water is discharged overboard from the treatment water overboard discharge line by the treatment water overboard discharge unit. Therefore, treatment water in which small-sized microorganisms, bacteria, and the like have been killed by the ultraviolet treatment can be discharged overboard. Furthermore, an ultraviolet treatment of treatment target water is not performed when treatment target water is sucked, and treatment water is sterilized by an ultraviolet treatment and discharged overboard when treatment water is discharged overboard. Therefore, the running cost such as ultraviolet lamps can be reduced.

The invention according to claim 2 is the ballast water treatment device according to claim 1, in which the treatment target water overboard discharge line is connected to the ballast water treatment line between the treatment target water suction pump and the filter, a treatment target water overboard discharge valve constituting the treatment target water overboard discharge unit is disposed to the treatment target water overboard discharge line, and a treatment water valve is disposed to the ballast water treatment line between the filter and the treatment target water overboard discharge line connected between the treatment target water suction pump and the filter.

According to the invention of claim 2, a simple operation is performed in which when sucked treatment target water is discharged overboard from the treatment target water overboard discharge line without passing through the filter, the treatment water valve disposed to the ballast water treatment line is closed, and the treatment target water overboard discharge valve constituting the treatment target water overboard discharge unit is opened, and after a prescribed time elapsed, the overboard discharge of treatment target water from the treatment target water overboard discharge line is terminated. Furthermore, when treatment target water passes through the filter, the treatment water valve disposed to the ballast water treatment line is opened, and the treatment target water overboard discharge valve constituting the treatment target water overboard discharge unit is closed.

The invention according to claim 3 is the ballast water treatment device according to claim 2, in which a treatment target water suction valve is provided to the ballast water treatment line on the upstream side of the treatment target water suction pump, the treatment target water suction pump also serves as the treatment water suction pump provided to the treatment water overboard discharge line, the treatment water overboard discharge line includes a treatment water suction line having one end connected to the ballast water treatment line between the treatment target water suction valve and the treatment target water suction pump and the other end connected to the ballast tank and a treatment water discharge line having one end connected to the ballast water treatment line between the treatment target water suction pump and the treatment water valve, and the treatment water discharge line includes the ultraviolet reactor and the treatment water overboard discharge unit.

According to the invention of claim 3, the treatment target water suction valve is provided to the ballast water treatment line on the upstream side of the treatment target water suction pump, and the treatment target water suction pump also serves as the treatment water suction pump provided to the treatment water overboard discharge line. This enables a simple configuration and a miniaturized ballast water treatment device.

The invention according to claim 4 is the ballast water treatment device according to claim 3, in which the treatment water discharge line in the treatment water overboard discharge line is shared with the treatment target water overboard discharge line, the treatment target water overboard discharge unit also serves as the treatment water overboard discharge unit, a bypass line including the ultraviolet reactor is disposed to the treatment target water overboard discharge line on the upstream side of the treatment target water overboard discharge unit. Furthermore, when treatment water is sucked, treatment water in the ballast tank is sucked by the treatment target water suction pump that also serves as the treatment water suction pump, sucked treatment water is treated with ultraviolet radiation in the ultraviolet reactor provided to the bypass line disposed to the treatment target water overboard discharge line that also serves as the treatment water discharge line, and treated treatment water is discharged overboard from the treatment water overboard discharge line by the treatment target water overboard discharge unit that also serves as the treatment water overboard discharge unit.

According to the invention of claim 4, the treatment water discharge line in the treatment water overboard discharge line is shared with the treatment target water overboard discharge line, the treatment target water overboard discharge unit also serves as the treatment water overboard discharge unit, and the bypass line including the ultraviolet reactor is disposed to the treatment target water overboard discharge line on the upstream side of the treatment target water overboard discharge unit. This enables a further simple configuration and a further miniaturized ballast water treatment device.

The invention according to claim 5 is the ballast water treatment device according to any one of claims 1 to 4, in which: an ultraviolet sensor that measures ultraviolet illuminance in the ultraviolet reactor is provided; the treatment water overboard discharge line between the ultraviolet reactor and the treatment water overboard discharge unit is connected to the ballast water treatment line on the downstream side of the filter; and when treatment water is sucked, treatment water passes through the ultraviolet reactor, an ultraviolet treatment of treatment water passing through the ultraviolet reactor is started to adjust ultraviolet illuminance, and treatment water is returned to the ballast tank without being discharged overboard until illuminance measured by the ultraviolet sensor reaches prescribed illuminance, and when the prescribed illuminance has been reached, treatment water is discharged overboard from the treatment water overboard discharge line by the treatment water overboard discharge unit.

According to the invention of claim 5, when treatment water is sucked, treatment water passes through the ultraviolet reactor, an ultraviolet treatment of treatment water passing through the ultraviolet reactor is started to adjust ultraviolet illuminance, and treatment water is returned to the ballast tank without being discharged overboard until illuminance measured by the ultraviolet sensor reaches prescribed illuminance, and treatment water is discharged overboard from the treatment water overboard discharge line by the treatment water overboard discharge unit when the prescribed illuminance has been reached. Therefore, treatment water having been reliably sterilized by the ultraviolet treatment can be discharged overboard.

The invention according to claim 6 is the ballast water treatment device according to claim 4, in which: an ultraviolet sensor that measures ultraviolet illuminance in the ultraviolet reactor is provided; the bypass line on the downstream side of the ultraviolet reactor is connected to the ballast water treatment line on the downstream side of the filter; and when treatment water is sucked, treatment water passes through the ultraviolet reactor, an ultraviolet treatment of treatment water passing through the ultraviolet reactor is started to adjust ultraviolet illuminance, and treatment water returns to the ballast tank without being discharged overboard until illuminance measured by the ultraviolet sensor reaches prescribed illuminance, and when the prescribed illuminance has been reached, treatment water is discharged overboard from the treatment water overboard discharge line by the treatment water overboard discharge unit.

According to the invention of claim 6, when treatment water is sucked, treatment water passes through the ultraviolet reactor, an ultraviolet treatment of treatment water passing through the ultraviolet reactor is started to adjust ultraviolet illuminance, and treatment water returns to the ballast tank without being discharged overboard until illuminance measured by the ultraviolet sensor reaches prescribed illuminance, and treatment water is discharged overboard from the treatment water overboard discharge line by the treatment water overboard discharge unit when the prescribed illuminance has been reached. Therefore, treatment water having been reliably sterilized by the ultraviolet treatment can be discharged overboard.

### Effects of the Invention

According to the ballast water treatment device of the present invention, when treatment target water is sucked, sucked treatment target water is discharged overboard without passing through the filter for a prescribed time from the start of suction of treatment target water by the treatment target water suction pump, and when the prescribed time elapsed, the overboard discharge is terminated, treatment target water passes through the filter to be filtered, and filtered treatment water is poured into the ballast tank. Therefore, clogging of the filter due to the turbidity during suction can be mitigated. Furthermore, treatment water in which large-sized microorganisms or the like present in treatment target water have been trapped by the filtration treatment with the filter can be poured into the ballast tank.

In addition, when treatment water is sucked, sucked treatment water passes through the ultraviolet reactor to be treated with ultraviolet radiation, and is then discharged overboard. Therefore, treatment water in which small-sized microorganisms, bacteria, and the like have been killed by the ultraviolet treatment can be discharged overboard. Furthermore, an ultraviolet treatment of treatment target water is not performed when treatment target water is sucked, and treatment water is sterilized by an ultraviolet treatment and discharged overboard when treatment water is discharged overboard. Therefore, the running cost such as ultraviolet lamps can be reduced.

### BRIEF DESCRIPTION OF THE DRAWINGS

FIG. 1 is a schematic configuration diagram illustrating a first example of an embodiment of a ballast water treatment device according to the present invention.

FIG. 2 is a schematic configuration diagram illustrating a second example of an embodiment of the ballast water treatment device according to the present invention.

FIG. 3 is a schematic configuration diagram illustrating a third example of an embodiment of the ballast water treatment device according to the present invention.

FIG. 4 is a schematic configuration diagram illustrating a fourth example of an embodiment of the ballast water treatment device according to the present invention.

### DESCRIPTION OF PREFERRED EMBODIMENTS

Hereinafter, embodiments of the ballast water treatment device according to the present invention will be described in detail with reference to the drawings.

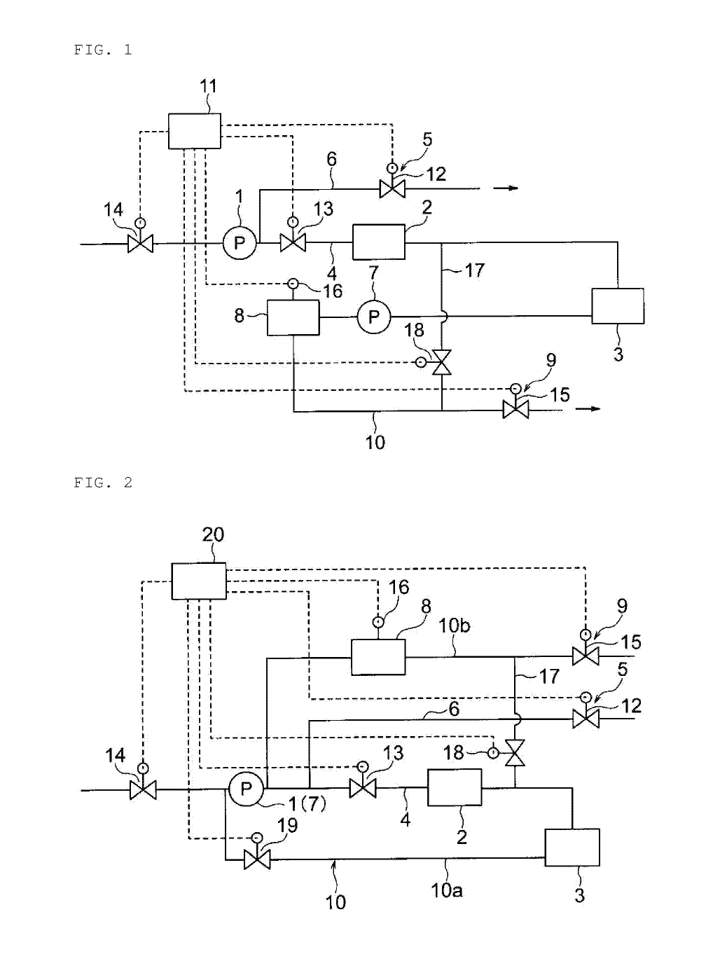

First, the first example of an embodiment of the ballast water treatment device according to the present invention will be described by referring to the schematic configuration diagram illustrated in FIG. 1.

The ballast water treatment device according to the present example includes: a ballast water treatment line 4 having a treatment target water suction pump 1 that sucks treatment target water, a filter 2 that filters sucked treatment target water, and a ballast tank 3 that stores filtered treatment water, in this order; a treatment target water overboard discharge line 6 having a treatment target water overboard discharge unit 5 that discharges sucked treatment target water overboard; a treatment water overboard discharge line 10 having a treatment water suction pump 7 that sucks treatment water in the ballast tank 3, an ultraviolet reactor 8 that treats sucked treatment water with ultraviolet radiation, and a treatment water overboard discharge unit 9 that discharges treatment water treated with ultraviolet radiation overboard; and a controller 11 having control functions of, when treatment target water is sucked, discharging sucked treatment target water overboard from the treatment target water overboard discharge line 6 by the treatment target water overboard discharge unit 5 without allowing treatment target water to pass through the filter 2 for a prescribed time from the start of suction of treatment target water by the treatment target water suction pump 1, and when the prescribed time elapsed, terminating the overboard discharge from the treatment target water overboard discharge line 6 by the treatment target water overboard discharge unit 5, allowing treatment target water to pass through the filter 2 and be filtered, and pouring filtered treatment water into the ballast tank 3, and when treatment water is sucked, sucking treatment water in the ballast tank 3 by the treatment water suction pump 7, allowing treatment water to pass through the ultraviolet reactor 8 and be treated with ultraviolet radiation, and discharging treatment water treated with ultraviolet radiation overboard from the treatment water overboard discharge line 10 by the treatment water overboard discharge unit 9.

In the present example, the elapsed time from the start of suction of treatment target water is checked by a timer (not illustrated) provided to the controller 11.

As described herein, the prescribed time from the start of suction of treatment target water is set to be a time for which temporary increase in turbidity due to the stirring up of mud and sand on the sea bottom (lake bottom, river bottom, or the like) in the vicinity of a suction port, called a sea chest (not illustrated), caused by suction decreases to around the turbidity before the start of suction.

In the present example, the treatment target water overboard discharge line 6 is connected to the ballast water treatment line 4 between the treatment target water suction pump 1 and the filter 2, and a treatment target water overboard discharge valve 12 constituting the treatment target water overboard discharge unit 5 is disposed to the treatment target water overboard discharge line 6. A treatment water valve 13 is disposed to the ballast water treatment line 4 between the filter 2 and the treatment target water overboard discharge line 6 connected between the treatment target water suction pump 1 and the filter 2. Furthermore, a treatment target water suction valve 14 is disposed to the ballast water treatment line 4 on the upstream side of the treatment target water suction pump 1. Furthermore, a treatment water overboard discharge valve 15 constituting the treatment water overboard discharge unit 9 is disposed to the treatment water overboard discharge line 10.

Control by the controller 11 is performed by controlling the opening and closing of the treatment target water overboard discharge valve 12 constituting the treatment target water overboard discharge unit 5, the treatment water valve 13, the treatment water overboard discharge valve 15 constituting the treatment water overboard discharge unit 9, and the treatment target water suction valve 14.

In the present example, an ultraviolet sensor 16 that measures ultraviolet illuminance in the ultraviolet reactor 8 is provided, the treatment water overboard discharge line 10 between the ultraviolet reactor 8 and the treatment water overboard discharge unit 9 is connected to the ballast water treatment line 4 on the downstream side of the filter 2 via a treatment water return line 17, and a treatment water return valve 18 is provided to the treatment water return line 17. Furthermore, the controller 11 has control functions of, when treatment water is sucked, allowing sucked treatment water to pass through the ultraviolet reactor 8, starting an ultraviolet treatment of treatment water passing through the ultraviolet reactor 8 to adjust ultraviolet illuminance, allowing treatment water to pass through the treatment water return line 17 and return to the ballast tank 3 without being discharged overboard until illuminance measured by the ultraviolet sensor 16 reaches prescribed illuminance, and when the prescribed illuminance has been reached, discharging treatment water overboard from the treatment water overboard discharge line 10 by the treatment water overboard discharge unit 9. Such control by these control functions is performed by controlling the opening and closing of the treatment water overboard discharge valve 15 constituting the treatment water overboard discharge unit 9 and the treatment water return valve 18 disposed to the treatment water return line 17.

The treatment of treatment target water by the ballast water treatment device according to the first example configured as described above is performed in the following manner.

First, when treatment target water is sucked, the treatment water valve 13 is closed, the treatment target water overboard discharge valve 12 and the treatment target water suction valve 14 are opened, and the treatment target water suction pump 1 is started up. The starting up of the treatment target water suction pump 1 causes treatment target water to flow into the treatment target water overboard discharge line 6, so that treatment target water is discharged overboard by the treatment target water overboard discharge unit 5 without passing through the filter 2.

When the suction of treatment target water is started, a timer provided to the control unit 11 starts counting. When a prescribed time has elapsed since the suction of treatment target water was started, the treatment water valve 13 is opened, the treatment target water overboard discharge valve 12 is closed, and the treatment water return valve 18 disposed to the treatment water return line 17 is closed if it is opened. Accordingly, the overboard discharge of treatment target water is terminated, treatment target water passes through the filter 2, and treatment water filtered through the filter 2 is delivered as ballast water into the ballast tank 3.

It is noted that the timing at which the overboard discharge of treatment target water is terminated may be when it is confirmed that a prescribed time has elapsed since the suction of treatment target water was started, or may be after a prescribed time has elapsed.

Next, when treatment water is sucked, the treatment water return valve 18 is opened, the treatment water valve 13, the treatment target water suction valve 14, and the treatment water overboard discharge valve 15 are closed, and the treatment water suction pump 7 is started up. Treatment water sucked from the ballast tank 3 in response to the starting up of the treatment water suction pump 7 flows into the treatment water overboard discharge line 10, passes through the ultraviolet reactor 8, and is treated with ultraviolet radiation in the ultraviolet reactor 8. Treatment water treated with ultraviolet radiation flows through the treatment water return line 17, flows through the ballast water treatment line 4, and returns to the ballast tank 3.

When an ultraviolet treatment of treatment water passing through the ultraviolet reactor 8 is started to adjust ultraviolet illuminance, and illuminance measured by the ultraviolet sensor 16 reaches prescribed illuminance, the treatment water return valve 18 is closed, and the treatment water overboard discharge valve 15 is opened. Accordingly, treatment water in which microorganisms or the like have been killed by the ultraviolet treatment is discharged overboard. The timing of closing the treatment water return valve 18 and opening the treatment water overboard discharge valve 15 may be when it is confirmed that illuminance measured by the ultraviolet sensor 16 has reached prescribed illuminance, or may be after prescribed illuminance has been reached.

Next, the second example of an embodiment of the ballast water treatment device according to the present invention will be described by referring to the schematic configuration diagram illustrated in FIG. 2.

The ballast water treatment device according to the present example has the same fundamental configuration as the first example, and the same configuration as the first example is assigned with the same reference numeral. In the present example, descriptions overlapping with the first example will be appropriately omitted.

In the present example, the treatment target water suction pump 1 also serves as the treatment water suction pump 7 provided to the treatment water overboard discharge line 10. The treatment water overboard discharge line 10 includes: a treatment water suction line 10a having one end connected to the ballast water treatment line 4 between the treatment target water suction valve 14 and the treatment target water suction pump 1 (7) and the other end connected to the ballast tank 3; and a treatment water discharge line 10b having one end connected to the ballast water treatment line 4 between the treatment target water suction pump 1 (7) and the treatment water valve 13. The section of the ballast water treatment line 4 between one end of the treatment water suction line 10a and one end of the treatment water discharge line 10b is shared with the treatment water overboard discharge line 10. The treatment water discharge line 10b is provided with the ultraviolet reactor 8 and the treatment water overboard discharge unit 9. The treatment water suction line 10a is provided with a treatment water suction valve 19.

The present example includes a controller 20 having control functions of: discharging treatment target water overboard from the treatment target water overboard discharge line 6 by the treatment target water overboard discharge unit 5; and discharging treatment water overboard from the treatment water overboard discharge line 10 by the treatment water overboard discharge unit 9.

The controls of discharging treatment target water overboard and discharging treatment water overboard by the controller 20 are performed by controlling the opening and closing of the treatment target water overboard discharge valve 12 constituting the treatment target water overboard discharge unit 5, the treatment water valve 13, the treatment water overboard discharge valve 15 constituting the treatment water overboard discharge unit 9, the treatment target water suction valve 14, the treatment water return valve 18, and the treatment water suction valve 19.

The controller 20 is provided with a timer (not illustrated) in a similar manner to the controller 11 of the first example, and checks a time that has elapsed since the suction of treatment target water was started.

The treatment of treatment target water by the ballast water treatment device according to the second example configured as described above is performed in the following manner.

First, when treatment target water is sucked, the treatment water valve 13, the treatment water overboard discharge valve 15, the treatment water return valve 18, and the treatment water suction valve 19 are closed, the treatment target water overboard discharge valve 12 and the treatment target water suction valve 14 are opened, and the treatment target water suction pump 1 (7) is started up. The starting up of the treatment target water suction pump 1 (7) causes treatment target water to flow into the treatment target water overboard discharge line 6, so that treatment target water is discharged overboard by the treatment target water overboard discharge unit 5 without passing through the filter 2.

When the suction of treatment target water is started, a timer provided to the control unit 20 starts counting. When a prescribed time has elapsed since the suction of treatment target water was started, the treatment water valve 13 is opened, and the treatment target water overboard discharge valve 12 is closed. Accordingly, the overboard discharge of treatment target water is terminated, treatment target water passes through the filter 2, and treatment water filtered through the filter 2 is delivered as ballast water into the ballast tank 3.

It is noted that the timing at which the overboard discharge of treatment target water is terminated may be when it is confirmed that a prescribed time has elapsed since the suction of treatment target water was started, or may be after a prescribed time has elapsed.

Next, when treatment water is sucked, the treatment water return valve 18 and the treatment water suction valve 19 are opened, the treatment water valve 13, the treatment target water suction valve 14, and the treatment water overboard discharge valve 15 are closed, and the treatment water suction pump 7 (1) is started up. Treatment water sucked from the ballast tank 3 in response to the starting up of the treatment water suction pump 7 (1) flows through the treatment water suction line 10a, the section of the ballast water treatment line 4 between one end of the treatment water suction line 10a and one end of the treatment water discharge line 10b, and the treatment water discharge line 10b, in this order, and is treated with ultraviolet radiation in the ultraviolet reactor 8 provided to the treatment water discharge line 10b. Treatment water treated with ultraviolet radiation flows through the treatment water return line 17, flows through the ballast water treatment line 4, and returns to the ballast tank 3.

When an ultraviolet treatment of treatment water passing through the ultraviolet reactor 8 is started to adjust ultraviolet illuminance, and illuminance measured by the ultraviolet sensor 16 reaches prescribed illuminance, the treatment water return valve 18 is closed, and the treatment water overboard discharge valve 15 is opened. Accordingly, treatment water in which microorganisms or the like have been killed by the ultraviolet treatment is discharged overboard. The timing of closing the treatment water return valve 18 and opening the treatment water overboard discharge valve 15 may be when it is confirmed that illuminance measured by the ultraviolet sensor 16 has reached prescribed illuminance, or may be after prescribed illuminance has been reached.

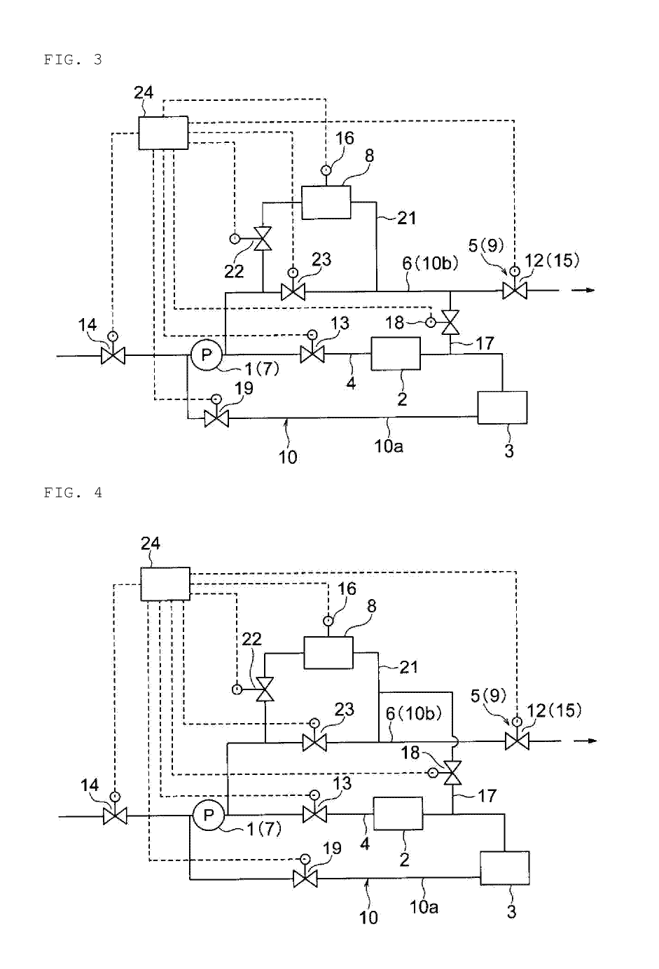

Next, the third example of an embodiment of the ballast water treatment device according to the present invention will be described by referring to the schematic configuration diagram illustrated in FIG. 3.

The ballast water treatment device according to the present example has the same fundamental configuration as the second example, and the same configuration as the second example is assigned with the same reference numeral. In the present example, descriptions overlapping with the second example will be appropriately omitted.

In the present example, the treatment water discharge line 10b in the treatment water overboard discharge line 10 is shared with the treatment target water overboard discharge line 6, and the treatment target water overboard discharge unit 5 also serves as the treatment water overboard discharge unit 9. Furthermore, a bypass line 21 provided with the ultraviolet reactor 8 is disposed to the treatment target water overboard discharge line 6 on the upstream side of the treatment target water overboard discharge unit 5 (9). A bypass valve 22 is disposed to the bypass line 21 on the upstream side of the ultraviolet reactor 8, and a treatment target water valve 23 is disposed to the treatment target water overboard discharge line 6 between the upstream end connection site and the downstream end connection site of the bypass line 21.

Furthermore, in the present example, the treatment water return line 17 has: one end connected to the treatment water overboard discharge line 10b (6) between the downstream end connection site of the bypass line 21 and the treatment water overboard discharge unit 9; and the other end connected to the ballast water treatment line 4 on the downstream side of the filter 2.

The present example includes a controller 24 having control functions of: discharging treatment target water overboard from the treatment target water overboard discharge line 6 by the treatment target water overboard discharge unit 5; and discharging treatment water overboard from the treatment water overboard discharge line 10 by the treatment water overboard discharge unit 9.

The controls of discharging treatment target water overboard and discharging treatment water overboard by the controller 24 are performed by controlling the opening and closing of the treatment target water overboard discharge valve 12 constituting the treatment target water overboard discharge unit 5, the treatment water valve 13, the treatment water overboard discharge valve 15 constituting the treatment water overboard discharge unit 9, the treatment target water suction valve 14, the treatment water return valve 18, the treatment water suction valve 19, the bypass valve 22, and the treatment target water valve 23.

The controller 24 is provided with a timer (not illustrated) in a similar manner to the controller 11 of the first example, and checks a time that has elapsed since the suction of treatment target water was started.

The treatment of treatment target water by the ballast water treatment device according to the third example configured as described above is performed in the following manner.

First, when treatment target water is sucked, the treatment water valve 13, the treatment water return valve 18, the treatment water suction valve 19, and the bypass valve 22 are closed, the treatment target water overboard discharge valve 12 (15), the treatment target water suction valve 14, and the treatment target water valve 23 are opened, and the treatment target water suction pump 1 (7) is started up. The starting up of the treatment target water suction pump 1 (7) causes treatment target water to flow into the treatment target water overboard discharge line 6 (10b), so that treatment target water is discharged overboard by the treatment target water overboard discharge unit 5 (9) without passing through the filter 2.

When the suction of treatment target water is started, a timer provided to the control unit 24 starts counting. When a prescribed time has elapsed since the suction of treatment target water was started, the treatment water valve 13 is opened, and the treatment target water overboard discharge valve 12 (15) is closed. Accordingly, the overboard discharge of treatment target water is terminated, treatment target water passes through the filter 2, and treatment water filtered through the filter 2 is delivered as ballast water into the ballast tank 3.

It is noted that the timing at which the overboard discharge of treatment target water is terminated may be when it is confirmed that a prescribed time has elapsed since the suction of treatment target water was started, or may be after a prescribed time has elapsed.

Next, when treatment water is sucked, the treatment water return valve 18, the treatment water suction valve 19, and the bypass valve 22 are opened, the treatment water valve 13, the treatment target water suction valve 14, and the treatment target water valve 23 are closed, and the treatment water suction pump 7 (1) is started up. Treatment water sucked from the ballast tank 3 in response to the starting up of the treatment water suction pump 7 (1) flows through the treatment water suction line 10a, the section of the ballast water treatment line 4 between one end of the treatment water suction line 10a and one end of the treatment water discharge line 10b(6), the section between one end of the treatment water discharge line 10b(6) and the upstream end connection site of the bypass line 21, and the bypass line 21, in this order. Then, treatment water is treated with ultraviolet radiation in the ultraviolet reactor 8 provided to the bypass line 21. Treatment water treated with ultraviolet radiation flows into the treatment water return line 17, flows through the ballast water treatment line 4, and returns to the ballast tank 3.

When an ultraviolet treatment of treatment water passing through the ultraviolet reactor 8 is started to adjust ultraviolet illuminance, and illuminance measured by the ultraviolet sensor 16 reaches prescribed illuminance, the treatment water return valve 18 is closed, and the treatment water overboard discharge valve 15 (12) is opened. Accordingly, treatment water in which microorganisms or the like have been killed by the ultraviolet treatment is discharged overboard. The timing of closing the treatment water return valve 18 and opening the treatment water overboard discharge valve 15 (12) may be when it is confirmed that illuminance measured by the ultraviolet sensor 16 has reached prescribed illuminance, or may be after prescribed illuminance has been reached.

Next, the fourth example of an embodiment of the ballast water treatment device according to the present invention will be described by referring to the schematic configuration diagram illustrated in FIG. 4.

The ballast water treatment device according to the present example has the same fundamental configuration as the third example, and the same configuration as the third example is assigned with the same reference numeral. In the present example, descriptions overlapping with the third example will be appropriately omitted.

In the present example, the treatment water return line 17 has: one end connected to the bypass line 21 on the downstream side of the ultraviolet reactor 8; and the other end connected to the ballast water treatment line 4 on the downstream side of the filter 2. The configuration other than the above is the same as the third example.

The treatment of treatment target water by the ballast water treatment device according to the fourth example configured as described above includes, in a similar manner to the third example, discharging treatment target water overboard from the treatment target water overboard discharge line 6 by the treatment target water overboard discharge unit 5, and discharging treatment water overboard from the treatment water overboard discharge line 10 by the treatment water overboard discharge unit 9, under control by the controller 24.

It is noted that in the above-described first to fourth examples of an embodiment of the ballast water treatment device according to the present invention, when treatment water is sucked, an ultraviolet treatment of treatment water passing through the ultraviolet reactor 8 is started to adjust ultraviolet illuminance, treatment water returns to the ballast tank 3 without being discharged overboard until illuminance measured by the ultraviolet sensor 16 reaches prescribed illuminance, and treatment water is discharged overboard from the treatment water overboard discharge line 10 by the treatment water overboard discharge unit 9 when the prescribed illuminance has been reached. However, as another example, when sucked, an ultraviolet treatment of treatment water passing through the ultraviolet reactor 8 may be performed, and treatment water treated with ultraviolet radiation may be discharged overboard from the treatment water overboard discharge line 10 by the treatment water overboard discharge unit 9 without returning to the ballast tank 3.

The present invention can be implemented in various other forms without departing from its spirit or essential characteristics. Therefore, the above-described embodiments or examples are merely illustrative in any aspect and should not be interpreted in a limiting manner. The scope of the present invention is indicated by the claims, and not restricted by the description of this specification. Furthermore, all modifications and changes belonging to the range equivalent to the claims fall within the scope of the present invention.

### DESCRIPTION OF REFERENCE SIGNS

1 treatment target water suction pump
2 filter
3 ballast tank
4 ballast water treatment line
5 treatment target water overboard discharge unit
6 treatment target water overboard discharge line
7 treatment water suction pump
8 ultraviolet reactor
9 treatment water overboard discharge unit
10 treatment water overboard discharge line
10a treatment water suction line
10b treatment water discharge line
11, 20, 24 controller
12 treatment target water overboard discharge valve
13 treatment water valve
14 treatment target water suction valve
16 ultraviolet sensor
21 bypass line

What is claimed is:

1. A ballast water treatment device, comprising:
a ballast water treatment line including a treatment target water suction pump that sucks treatment target water, a filter that filters sucked treatment target water, and a ballast tank that stores filtered treatment water, in this order;
a treatment target water overboard discharge line including a treatment target water overboard discharge unit that discharges sucked treatment target water overboard; and
a treatment water overboard discharge line including a treatment water suction pump that sucks treatment water in the ballast tank, an ultraviolet reactor that treats sucked treatment water with ultraviolet radiation, and a treatment water overboard discharge unit that discharges treatment water treated with ultraviolet radiation overboard, wherein
when treatment target water is sucked, sucked treatment target water is discharged overboard from the treatment target water overboard discharge line by the treatment target water overboard discharge unit without passing through the filter for a prescribed time from the start of suction of treatment target water by the treatment target water suction pump, and
when the prescribed time elapsed, the overboard discharge from the treatment target water overboard discharge line by the treatment target water overboard discharge unit is terminated, treatment target water passes through the filter to be filtered, and filtered treatment water is poured into the ballast tank.

2. (canceled)

3. (canceled)

4. (canceled)

5. (canceled)

6. (canceled)

7. The ballast water treatment device according to claim 1, wherein
when treatment water is sucked, treatment water in the ballast tank is sucked by the treatment water suction pump, sucked treatment water passes through the ultraviolet reactor to be treated with ultraviolet radiation, and treated treatment water is discharged overboard from the treatment water overboard discharge line by the treatment water overboard discharge unit.

8. The ballast water treatment device according to claim 7, wherein
the treatment target water overboard discharge line is connected to the ballast water treatment line between the treatment target water suction pump and the filter, and a treatment target water overboard discharge valve constituting the treatment target water overboard discharge unit is disposed to the treatment target water overboard discharge line, and
a treatment water valve is disposed to the ballast water treatment line between the filter and the treatment target water overboard discharge line connected between the treatment target water suction pump and the filter.

9. The ballast water treatment device according to claim 8, wherein
a treatment target water suction valve is provided to the ballast water treatment line on an upstream side of the treatment target water suction pump,
the treatment target water suction pump also serves as the treatment water suction pump provided to the treatment water overboard discharge line,
the treatment water overboard discharge line includes a treatment water suction line having one end connected to the ballast water treatment line between the treatment target water suction valve and the treatment target water suction pump and the other end connected to the ballast tank and a treatment water discharge line having one end connected to the ballast water treatment line between the treatment target water suction pump and the treatment water valve, and
the treatment water discharge line includes the ultraviolet reactor and the treatment water overboard discharge unit.

10. The ballast water treatment device according to claim 9, wherein
the treatment water discharge line in the treatment water overboard discharge line is shared with the treatment target water overboard discharge line, and the treatment target water overboard discharge unit also serves as the treatment water overboard discharge unit,
a bypass line including the ultraviolet reactor is disposed to the treatment target water overboard discharge line on an upstream side of the treatment target water overboard discharge unit, and
when treatment water is sucked, treatment water in the ballast tank is sucked by the treatment target water suction pump that also serves as the treatment water suction pump, sucked treatment water is treated with ultraviolet radiation in the ultraviolet reactor provided to the bypass line disposed to the treatment target water overboard discharge line that also serves as the treatment water discharge line, and treated treatment water is discharged overboard from the treatment water overboard discharge line by the treatment target water overboard discharge unit that also serves as the treatment water overboard discharge unit.

11. The ballast water treatment device according to claim 7, wherein
an ultraviolet sensor that measures ultraviolet illuminance in the ultraviolet reactor is provided, and the treatment water overboard discharge line between the ultraviolet reactor and the treatment water overboard discharge unit is connected to the ballast water treatment line on a downstream side of the filter, and
when treatment water is sucked, treatment water passes through the ultraviolet reactor, an ultraviolet treatment of treatment water passing through the ultraviolet reactor is started to adjust ultraviolet illuminance, and treatment water returns to the ballast tank without being discharged overboard until illuminance measured by the ultraviolet sensor reaches prescribed illuminance, and when the prescribed illuminance has been reached, treatment water is discharged overboard from the treatment water overboard discharge line by the treatment water overboard discharge unit.

12. The ballast water treatment device according to claim 8, wherein
an ultraviolet sensor that measures ultraviolet illuminance in the ultraviolet reactor is provided, and the treatment water overboard discharge line between the ultraviolet reactor and the treatment water overboard discharge unit is connected to the ballast water treatment line on a downstream side of the filter, and
when treatment water is sucked, treatment water passes through the ultraviolet reactor, an ultraviolet treatment of treatment water passing through the ultraviolet reactor is started to adjust ultraviolet illuminance, and treatment water returns to the ballast tank without being discharged overboard until illuminance measured by the ultraviolet sensor reaches prescribed illuminance, and when the prescribed illuminance has been reached, treatment water is discharged overboard from the treatment water overboard discharge line by the treatment water overboard discharge unit.

13. The ballast water treatment device according to claim 9, wherein
an ultraviolet sensor that measures ultraviolet illuminance in the ultraviolet reactor is provided, and the treatment water overboard discharge line between the ultraviolet reactor and the treatment water overboard discharge unit is connected to the ballast water treatment line on a downstream side of the filter, and
when treatment water is sucked, treatment water passes through the ultraviolet reactor, an ultraviolet treatment of treatment water passing through the ultraviolet reactor is started to adjust ultraviolet illuminance, and treatment water returns to the ballast tank without being discharged overboard until illuminance measured by the ultraviolet sensor reaches prescribed illuminance, and when the prescribed illuminance has been reached, treatment water is discharged overboard from the treatment water overboard discharge line by the treatment water overboard discharge unit.

14. The ballast water treatment device according to claim 10, wherein
an ultraviolet sensor that measures ultraviolet illuminance in the ultraviolet reactor is provided, and the treatment water overboard discharge line between the ultraviolet reactor and the treatment water overboard discharge unit is connected to the ballast water treatment line on a downstream side of the filter, and
when treatment water is sucked, treatment water passes through the ultraviolet reactor, an ultraviolet treatment of treatment water passing through the ultraviolet reactor is started to adjust ultraviolet illuminance, and treatment water returns to the ballast tank without being discharged overboard until illuminance measured by the ultraviolet sensor reaches prescribed illuminance, and when the prescribed illuminance has been reached, treatment water is discharged overboard from the treatment water overboard discharge line by the treatment water overboard discharge unit.

15. The ballast water treatment device according to claim 10, wherein
an ultraviolet sensor that measures ultraviolet illuminance in the ultraviolet reactor is provided, and the bypass line on a downstream side of the ultraviolet reactor is connected to the ballast water treatment line on a downstream side of the filter, and
when treatment water is sucked, treatment water passes through the ultraviolet reactor, an ultraviolet treatment of treatment water passing through the ultraviolet reactor is started to adjust ultraviolet illuminance, and treatment water returns to the ballast tank without being discharged overboard until illuminance measured by the ultraviolet sensor reaches prescribed illuminance, and when the prescribed illuminance has been reached, treatment water is discharged overboard from the treatment water overboard discharge line by the treatment water overboard discharge unit.

16. The ballast water treatment device according to claim 1, wherein
the treatment target water overboard discharge line is connected to the ballast water treatment line between the treatment target water suction pump and the filter, and a treatment target water overboard discharge valve constituting the treatment target water overboard discharge unit is disposed to the treatment target water overboard discharge line, and
a treatment water valve is disposed to the ballast water treatment line between the filter and the treatment target water overboard discharge line connected between the treatment target water suction pump and the filter.

17. The ballast water treatment device according to claim 16, wherein
a treatment target water suction valve is provided to the ballast water treatment line on an upstream side of the treatment target water suction pump,
the treatment target water suction pump also serves as the treatment water suction pump provided to the treatment water overboard discharge line,
the treatment water overboard discharge line includes a treatment water suction line having one end connected to the ballast water treatment line between the treatment target water suction valve and the treatment target water suction pump and the other end connected to the ballast tank and a treatment water discharge line having one end connected to the ballast water treatment line between the treatment target water suction pump and the treatment water valve, and
the treatment water discharge line includes the ultraviolet reactor and the treatment water overboard discharge unit.

18. The ballast water treatment device according to claim 17, wherein
the treatment water discharge line in the treatment water overboard discharge line is shared with the treatment target water overboard discharge line, and the treatment target water overboard discharge unit also serves as the treatment water overboard discharge unit,
a bypass line including the ultraviolet reactor is disposed to the treatment target water overboard discharge line on an upstream side of the treatment target water overboard discharge unit, and
when treatment water is sucked, treatment water in the ballast tank is sucked by the treatment target water suction pump that also serves as the treatment water suction pump, sucked treatment water is treated with ultraviolet radiation in the ultraviolet reactor provided to the bypass line disposed to the treatment target water overboard discharge line that also serves as the treatment water discharge line, and treated treatment water is discharged overboard from the treatment water overboard discharge line by the treatment target water overboard discharge unit that also serves as the treatment water overboard discharge unit.
